(19) United States
(12) Patent Application Publication
(10) Pub. No.: US 2025/0107633 A1
(43) Pub. Date: Apr. 3, 2025

(54) COIL-IN-COIL SPRINGS AND SPRING CORES INCLUDING SAME

(71) Applicant: Sealy Technology LLC, Trinity, NC (US)

(72) Inventors: Kevin Tar, Summerfield, NC (US); Brian Manuszak, Thomasville, NC (US)

(21) Appl. No.: 18/904,776

(22) Filed: Oct. 2, 2024

Related U.S. Application Data
(60) Provisional application No. 63/542,008, filed on Oct. 2, 2023.

(51) Int. Cl. A47C 27/06; F16F 3/04

(52) U.S. Cl. CPC A47C 27/062; F16F 3/04

(57) ABSTRACT

A spring core of a mattress includes a first support zone with a plurality of pocketed coil-in-coil springs and a second support zone including a plurality of pocketed coil-in-coil springs. Each of the plurality of pocketed coil-in-coil springs includes an inner coil, and an outer coil extending around the inner coil. The plurality of pocketed coil-in-coil springs of the first support zone have a first compression characteristic and the plurality of pocketed coil-in-coil springs of the second support zone have a second compression characteristic different than the first compression characteristic. In some embodiments, the uncompressed height of the inner coils differs between the first support zone and the second support zone. In some embodiments, the gauge of the wire forming at least a portion of the inner coils or the outer coils differs between the first support zone and the second support zone.

### RELATED APPLICATIONS

This application claims priority from U.S. Provisional Application Ser. No. 63/542,008, filed Oct. 2, 2023, the entire disclosure of which is incorporated herein by this reference.

### TECHNICAL FIELD

The present invention relates to coil-in-coil springs and spring cores including the same. In particular, the present invention relates to coil-in-coil springs that exhibit different compression characteristics.

### BACKGROUND

Typically, when a uniaxial load is applied to a spring, the spring exhibits a linear compression rate. That is to say, it takes twice as much force to compress a typical spring two inches as it does to compress the same spring one inch. The linear response of springs is expressed by Hooke's law which states that the force (F) needed to extend or compress a spring by some distance (D) is proportional to that distance. This relationship is expressed mathematically as F=kD, where k represents the spring constant for a particular spring. A high spring constant indicates that the spring requires more force to compress, and a low spring constant means the spring requires less force to compress.

Linear response springs, such as certain wire coil springs, are commonly used as mattress innersprings in combination with padding and upholstery that surround the innersprings. Most mattress innersprings are comprised of an array of wire coil springs which are often adjoined by lacing end convolutions of the coil springs together with cross wires. An advantage of this arrangement is that it is inexpensive to manufacture. However, this type of innerspring often provides a firm and rigid mattress surface.

An alternative to an innerspring mattress is a mattress constructed of one or more foam layers. Unlike an innerspring mattress comprised of an array of wire coil springs, foam mattresses exhibit a non-linear response to forces applied to the mattress. In particular, a foam mattress provides more support as the load increases. For instance, a typical foam mattress provides increased support after it has been compressed approximately 60% of the maximum compression of the foam. The non-linear response of foam mattresses provides improved sleep comfort for a user. However, the mechanical properties of certain foam may degrade over time affecting the overall comfort of the foam mattress. Furthermore, foam mattresses are often more costly to produce than metal spring mattresses. Accordingly, an improved coil spring design that provides non-linear and variable responses would be both highly desirable and beneficial.

### SUMMARY

The present invention relates to coil-in-coil springs and spring cores including the same. In particular, the present invention relates to coil-in-coil springs that exhibit different compression characteristics.

In one exemplary embodiment of the present invention, a coil-in-coil spring includes a lower end convolution, an outer coil including a plurality of helical convolutions extending from the lower end convolution to an upper end convolution, and an inner coil including a plurality of helical convolutions extending from the lower end convolution to an upper end convolution. A first portion of the coil-in-coil spring is formed of a wire having a first gauge and a second portion of the coil-in-coil spring is formed of a wire having a second gauge different from the first gauge.

In some exemplary embodiments, the coil-in-coil spring is made of a continuous wire forming the inner coil and the outer coil.

In some exemplary embodiments, the first portion of the coil-in-coil spring includes the outer coil and the second portion of the coil-in-coil spring includes the inner coil.

In some exemplary embodiments, the first portion of the coil-in-coil spring includes a lower portion of both the outer coil and the inner coil and the second portion of the coil-in-coil spring includes an upper portion of both the inner coil and the outer coil.

In some other embodiments of the present invention, a spring core of a mattress includes a first support zone including a plurality of pocketed coil-in-coil springs, and a second support zone including a plurality of pocketed coil-in-coil springs. The plurality of pocketed coil-in-coil springs of the first support zone have a first compression characteristic and the plurality of pocketed coil-in-coil springs of the second support zone have a second compression characteristic different than the first compression characteristic.

In some exemplary embodiments, for each of the plurality of pocketed coil-in-coil springs of the first support zone, the inner coil has an first uncompressed height, and the outer coil has a second uncompressed height greater than the first uncompressed height. Likewise, for each of the plurality of pocketed coil-in-coil springs of the second support zone, the inner coil has a third uncompressed height greater than the first uncompressed height and less than the second uncompressed height, and the outer coil has the second uncompressed height.

In some other exemplary embodiments, for each of the plurality of pocketed coil-in-coil springs of the first support zone, the inner coil and the outer coil is made of a continuous wire having a single gauge, and for each of the plurality of pocketed coil-in-coil springs of the second support zone the inner coil is made of a continuous wire having a first gauge and the outer coil is made of a wire having a second gauge different than the first gauge.

In still other exemplary embodiments, for each of the plurality of pocketed coil-in-coil springs of the first support zone, the inner coil and the outer coil is made of a continuous wire having a single gauge, and for each of the plurality of pocketed coil-in-coil springs of the second support zone an upper portion of the inner coil and an upper portion of the outer coil is made of a wire having a first gauge and a lower portion of the inner coil and a lower portion of the outer coil is made of a continuous wire having a second gauge different than the first gauge.

Further features and advantages of the present invention will become evident to those of ordinary skill in the art after a study of the description, figures, and non-limiting examples in this document.

### BRIEF DESCRIPTION OF THE DRAWINGS

FIG. 1A is a side view of an exemplary coil-in-coil spring made in accordance with the present invention;

FIG. 1B is a side view of the coil-in-coil spring of FIG. 1A compressed a first predetermined compression distance;

FIG. 1C is a side view of the coil-in-coil spring of FIG. 1A compressed a second predetermined compression distance;

FIG. 2 is a side view of another exemplary coil-in-coil spring made in accordance with the present invention with different wire gauges forming the inner coil and the outer coil;

FIG. 3 is a side view of another exemplary coil-in-coil spring made in accordance with the present invention with different wire gauges forming an upper portion and a lower portion;

FIG. 4 is a side view of another exemplary coil-in-coil spring made in accordance with the present invention with a larger pitch between convolutions of the inner coil to increase the uncompressed height of the inner coil;

FIG. 5 is a side view of another exemplary coil-in-coil spring made in accordance with the present invention with a larger number of convolutions of the inner coil to increase the uncompressed height of the inner coil;

FIG. 6 is a schematic top view of an exemplary spring core made in accordance with the present invention;

FIG. 7 is a schematic top view of another exemplary spring core made in accordance with the present invention;

FIG. 8 is a schematic top view of another exemplary spring core made in accordance with the present invention;

FIG. 9 is a schematic top view of another exemplary spring core made in accordance with the present invention;

FIG. 10 is a schematic top view of another exemplary spring core made in accordance with the present invention;

FIG. 11A is a schematic top view of another exemplary spring core made in accordance with the present invention;

FIG. 11B is a side partial sectional view of a first exemplary pocketed coil-in-coil spring used in the spring core of FIG. 11A;

FIG. 11C is a side partial sectional view of a second exemplary pocketed coil spring used in the spring core of FIG. 11A; and

FIG. 11D is a side partial sectional view of a third exemplary pocketed coil-in-coil spring used in the spring core of FIG. 11A.

### DESCRIPTION OF EXEMPLARY EMBODIMENTS

The present invention includes coil-in-coil springs. In particular, the present invention includes coil-in-coil springs that exhibit different compression characteristics.

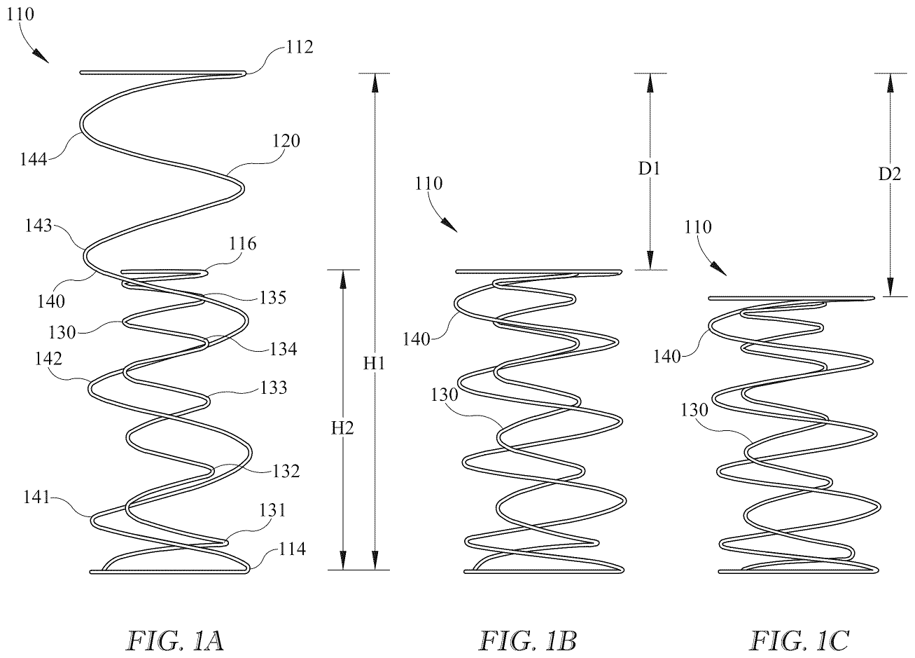

Referring first to FIG. 1A, in one exemplary embodiment, a coil-in-coil spring 110 is provided made of a continuous wire 120 forming an inner coil 130 having a substantially cylindrical shape and an outer coil 140 extending around the inner coil 130 and having a substantially cylindrical shape. More specifically, the inner coil 130 of the coil-in-coil spring 110 includes an upper end convolution 116 and a plurality (five) of helical convolutions 131-135 which extend in a clock-wise direction from a lower end convolution 114 of the coil-in-coil spring 110 to the upper end convolution 116 of the inner coil 130. Similarly, the outer coil 140 includes an upper end convolution 112 and a plurality (four) of helical convolutions 141-144 which extend in a counter-clockwise direction from the lower end convolution 114 of the coil-in-coil spring 110 to the upper end convolution 112 of the outer coil 140. Each convolution of the coil-in-coil spring 110 is made up of a portion of the continuous wire 120 substantially equal to about one turn of the continuous wire 120 (i.e., about 360° of the helical path of the continuous wire 120). The upper end convolution 112 of the outer coil 140 of the coil-in-coil spring 110 forms a substantially planar loop at the topmost portion of the coil-in-coil spring 110. Similarly, the lower end convolution 114 of the coil-in-coil spring 110 also forms a substantially planar loop at the lowermost portion of the coil-in-coil spring 110. In this way, the coil-in-coil spring 110 terminates at either end in a generally planar form which serves as the supporting end structures of the coil-in-coil spring 110. Likewise, the upper end convolution 116 of the inner coil 130 also forms a substantially planar loop, such that, upon a certain level of compression, the upper end convolution 116 of the inner coil 130 is substantially coplanar with the upper end convolution 112 of the outer coil 140, as discussed further below.

With further respect to the configuration of the coil-in-coil spring 110, in a typical coil spring formed with a helically-spiraling continuous wire, the spring constant and resultant feel of the coil spring are primarily determined by the wire gauge (or wire diameter), the total number of convolutions in the coil spring, the pitch between the convolutions of the coil spring, and the size of the convolutions (coil diameter). In this regard, the pitch (or vertical spacing) between each convolution of the coil spring is typically controlled by the rate at which the continuous wire, which forms the coil spring, is drawn through a forming die in a coil-forming machine. Once formed, a larger pitch will typically produce a stiffer coil spring due to the increased vertical orientation of the wire, while a smaller pitch will typically produce a softer coil spring and allow for a larger number of total convolutions in the coil body. Similarly, larger diameter convolutions in a coil spring also contribute to a lower spring constant and consequentially softer feel. Of course, because the wire forming the coil-in-coil spring is continuous there is no clearly defined beginning point or ending point of any single convolution. Furthermore, the diameter and pitch is typically adjusted gradually between one portion of the spring to another. As such, oftentimes a single convolution of the coil spring does not, in fact, have just one single diameter or just one single pitch, but may include, for example, a beginning or end portion with a variable diameter and/or pitch that transitions to the adjacent convolution. Therefore, as used herein, the diameter and pitch of a convolution will typically refer to an average diameter and pitch, but can also, in some embodiments, be inclusive of or refer to a maximum diameter and pitch or a minimum diameter and pitch.

In the exemplary coil-in-coil spring 110 shown in FIG. 1A, the continuous wire 120 ranges from about 10 gauge to about 20 gauge and in some particular embodiments about 13.75 gauge to about 17 gauge. Furthermore, the continuous wire 120 has a tensile strength of between about 200 kpsi to about 400 kpsi and in some particular embodiments between about 270 kpsi to about 320 kpsi. However, these ranges are merely exemplary and should not be considered limiting.

With respect to the diameters and pitches included in the coil-in-coil spring 110, and focusing more specifically on the outer coil 140 of the coil-in-coil spring 110, the upper end convolution 112 has a diameter and each of the four helical convolutions 141-144 has a diameter that are all substantially equal to one another. Specifically, in the exemplary coil-in-coil spring 110, the upper end convolution 112 of the outer coil 140 has a diameter of about 66 mm and each of the four helical convolutions 141-144 of the outer coil 140 has a diameter of about 70 mm. However, the particular diameters referenced above are merely exemplary and in some embodiments, the outer coil 140 may have coil diameters that range from about 50 mm to about 80 mm. The continuous wire 120 also defines a pitch between each of the four helical convolutions 141-144 of the outer coil 140, where each of the pitches are substantially equal to one another and, in the exemplary coil-in-coil spring 110, is about 66 mm. However, this pitch is merely exemplary and non-limiting. As discussed further below, the coil diameters and/or pitches of the outer coil may also vary along the height of the outer coil to provide a variety of coil-in-coil springs with varying compression characteristics.

Referring still to the exemplary coil-in-coil spring 110 shown in FIG. 1A, but focusing now on the inner coil 130 of the coil-in-coil spring 110, the upper end convolution 116 has a diameter and each of the five helical convolutions 131-135 has a diameter that are all substantially equal to one another but smaller than the diameter of the convolutions 141-144 of the outer coil 140. For example, the inner coil 130 may have coil diameters that range from about 30 mm to about 60 mm. The continuous wire 120 also defines a pitch between each of the five helical convolutions 131-135 of the inner coil 130, where each of the pitches are substantially equal to one another and less than the pitch between each of the four helical convolutions 141-144 of the outer coil 140. As discussed further below, the coil diameters and/or pitches of the inner coil may also vary along the height of the inner coil to provide a variety of coil-in-coil springs with varying compression characteristics.

When the coil-in-coil spring 110 is uncompressed, as shown in FIG. 1A, the outer coil 140 has an uncompressed height H1 that extends from the lower end convolution 114 of the coil-in-coil spring 110 to the upper end convolution 112 of the outer coil 140. In this regard, and as shown in FIG. 1A, the uncompressed height of the coil-in-coil spring 110 is the uncompressed height H1 of the outer coil 140. As also shown in FIG. 1A, the inner coil 130 has an uncompressed height H2 of about 75% of the uncompressed height H1 of the outer coil 140 (although the comparative height is not limited, as discussed further below) and extends from the lower end convolution 114 of the coil-in-coil spring 110 to the upper end convolution 116 of the inner coil 130, such that the upper end convolution 116 of the inner coil 130 is positioned a distance away from the upper end convolution 112 of the outer coil 140. As shown in FIG. 1B, when the coil-in-coil spring 110 is partially compressed a first predetermined compression distance D1, the outer coil 140 is compressed until the compressed height of the coil-in-coil spring 110 (i.e., the compressed height of the outer coil 140) is the same as the uncompressed height H2 of the inner coil 130. At that point, the upper end convolution 116 of the inner coil 130 is then substantially contained within and is coplanar with the upper end convolution 112 of the outer coil 140. Subsequently, however, as the coil-in-coil spring 110 is compressed beyond the first predetermined compression distance D1, both the outer coil 140 and the inner coil 130 compress simultaneously and the compressed height of the coil-in-coil spring 110 is the same as both the compressed height of the outer coil 140 and the compressed height of the inner coil 130.

As the coil-in-coil spring 110 compresses from the uncompressed state to the first predetermined compression distance D1, only the convolutions of the outer coil 140 compress and, as such, an initial spring constant K1 of the coil-in-coil spring 110 is based solely on the outer coil 140. Then, as shown in FIG. 1C, when the coil-in-coil spring 110 is compressed a second predetermined compression distance D2 greater than the first predetermined compression distance D1, the coil-in-coil spring 110 compresses beyond the first predetermined compression distance D1 and both the outer coil 140 and the inner coil 130 are compressed together. Accordingly, for compression distances beyond the first predetermined compression distance D1, a second spring constant K2 of the coil-in-coil spring 110 is based on both the inner coil 130 as well as the outer coil 140.

In operation, the coil-in-coil spring 110 functions substantially as two helical springs in parallel, where the effective spring constant is the sum of the spring constants of each spring that is actively engaged. Accordingly, when a force is applied to the coil-in-coil spring 110 and only the outer coil 140 begins to compress, the coil-in-coil spring 110 compresses at a constant rate according to the initial spring constant K1 until the coil-in-coil spring 110 has compressed a first predetermined compression distance D1. Then, once the coil-in-coil spring 110 has compressed beyond the first predetermined compression distance D1, the inner coil 130 is engaged and begins to compress along with the outer coil 140. In this way, initially the outer coil 140 alone provides support to a user's body positioned on the coil-in-coil spring 110, but upon compressing the first predetermined compression distance D1 the inner coil 130 and the outer coil 140 act together to provide support to a portion of the user's body positioned on the coil-in-coil spring 110. As the coil-in-coil spring 110 is compressed past the first predetermined compression distance D1, the coil-in-coil spring 110 compresses according to the second spring constant K2 of the coil-in-coil spring 110. In particular, the inner coil 130 and the outer coil 140 compress simultaneously, and the coil-in-coil spring 110 will compress at a constant rate according to the secondary spring constant K2 until the coil-in-coil spring 110 reaches a maximum compression distance of the coil-in-coil spring 110 where the inner coil 130, the outer coil 140, or both the inner coil 130 and the outer coil 140 are unable to compress further. The term “spring constant” as use herein is not limited to a typical linear response characteristic as in some embodiments, the inner coil and/or the outer coil are configured to have a non-linear response to compression.

As the spring constant increases (e.g., from K1 to K2), the coil-in-coil spring 110 becomes “harder.” Thus, the coil-in-coil spring 110 of the present invention provides a variable and non-linear response to loading.

With further respect to the spring constants of exemplary coil-in-coil spring 110, in the exemplary coil-in-coil spring 110, the spring constant of the inner coil 130 is higher than the spring constant of the outer coil 140. Of course, one skilled in the art would recognize that by modifying the inner coil 130 or the outer coil 140, the comparative values of the spring constants can be adjusted to provide further variability and customization of the spring constants and develop alternative compression characteristics in an exemplary coil-in-coil spring of the present invention. For example, in some embodiments, the spring constant of the inner coil is lower than the spring constant of the outer coil. In fact, it is contemplated that, in some particular embodiments, the spring constant of the inner coil is the same as the spring constant of the outer coil.

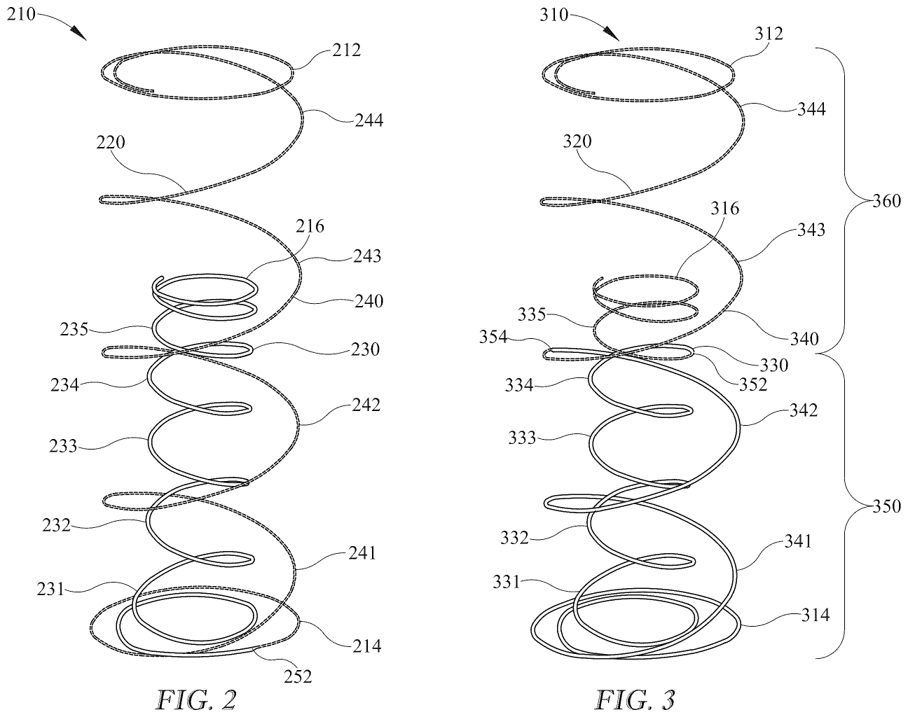

As described above, the spring constant of a coil spring is primarily determined by the wire gauge, the total number of convolutions in the coil spring, the pitch between the convolutions of the coil spring, and the coil diameter. As such, one means of changing the spring constants of the inner coil and/or outer coil is to change the gauge of the wire forming one or more portions of the coil-in-coil spring. Referring now to FIG. 2, in another exemplary embodiment, a coil-in-coil spring 210 is provided, which is similar to the coil-in-coil spring 110 shown in FIG. 1 except the gauge of the wire of the outer coil is different than the gauge of the wire of the inner coil. The coil-in-coil spring 210 of FIG. 2 is made of a continuous wire 220 forming an inner coil 230 having a substantially cylindrical shape and an outer coil 240 extending around the inner coil 230 and having a substantially cylindrical shape. More specifically, the inner coil 230 of the coil-in-coil spring 210 includes an upper end convolution 216 and a plurality (five) of helical convolutions 231-235 which extend in a clock-wise direction from a lower end convolution 214 of the coil-in-coil spring 210 to the upper end convolution 216 of the inner coil 230 similar to the inner coil 130 of the coil-in-coil spring 110 shown in FIG. 1. Likewise, the outer coil 240 includes an upper end convolution 212 and a plurality (four) of helical convolutions 241-244 which extend in a counter-clockwise direction from the lower end convolution 214 of the coil-in-coil spring 210 to the upper end convolution 212 of the outer coil 240 similar to the outer coil 140 of the coil-in-coil spring 110 shown in FIG. 1.

With respect to the diameters and pitches included in the coil-in-coil spring 210 of FIG. 2, the convolutions 241-244 of the outer coil 240 of the coil-in-coil spring 210 have diameters and pitches substantially similar to the outer coil 140 of the coil-in-coil spring 110 shown in FIG. 1, but this is not necessarily the same across all embodiments of the present invention.

Likewise, the convolutions 231-235 of the inner coil 230 of the coil-in-coil spring 210 of FIG. 2 have diameters and pitches substantially similar to the inner coil 130 of the coil-in-coil spring 110 shown in FIG. 1, but this is not necessarily the same across all embodiments of the present invention.

Similar to the coil-in-coil spring 110 shown in FIG. 1, in the exemplary coil-in-coil spring 210 shown in FIG. 2, the continuous wire 220 ranges from about 13.75 gauge to about 17 gauge. Furthermore, the continuous wire 220 has a tensile strength of between about 270 kpsi to about 320 kpsi, but this is not necessarily the same across all embodiments of the present invention.

However, while the wire gauge in the exemplary coil-in-coil spring 110 shown in FIG. 1 is substantially the same along the entire length of the continuous wire 120 (i.e., the gauge of the inner coil 130 is the same as the gauge of the outer coil 140), in the exemplary coil-in-coil spring 210 shown in FIG. 2, the wire gauge changes at a transition point 252 along the lower end convolution 214 such that the gauge of the wire forming the inner coil 230 is different than the gauge of the wire forming the outer coil 240 which is illustrated in FIG. 2 by the inner coil 230 drawn in solid lines and the outer coil 240 drawn in dashed lines. In some embodiments, the gauge of the wire forming the inner coil 230 is heavier than the gauge of the wire forming the outer coil 240 while in other embodiments, the gauge of the wire forming the inner coil 230 is lighter than the gauge of the wire forming the outer coil 240. For example, in one exemplary embodiment, the wire forming the outer coil 240 is 15 gauge and the wire forming the inner coil 230 is 14 gauge. In another exemplary embodiment, the wire forming the outer coil 240 is 14gauge and the wire forming the inner coil 230 is 15 gauge. In either event, by having a different wire gauge for the inner coil 230 and the outer coil 240, the coil-in-coil spring 210 shown in FIG. 2 has a different compression characteristic than the coil-in-coil spring 110 shown in FIG. 1.

Rather than changing the wire gauge between the inner coil and the outer coil, a different portion, or portions, of the inner coil and/or outer coil may also be formed from wire having different gauges. For example, instead of setting the transition point along the lower end convolution as shown in FIG. 2, in some embodiments, a transition point between different wire gauges can be set somewhere along the height of the inner coil or the outer coil. Furthermore, in some embodiments, multiple transition points are provided.

Referring now to FIG. 3, in yet another exemplary embodiment, a coil-in-coil spring 310 is provided, which is similar to the coil-in-coil spring 110 shown in FIG. 1 except the gauge of the wire of a lower portion 350 of the coil-in-coil spring 310 is different than the gauge of the wire of an upper portion 360 of the coil-in-coil spring 310. The coil-in-coil spring 310 of FIG. 3 is made of a continuous wire 320 forming an inner coil 330 having a substantially cylindrical shape and an outer coil 340 extending around the inner coil 330 and having a substantially cylindrical shape. More specifically, the inner coil 330 of the coil-in-coil spring 310 includes an upper end convolution 316 and a plurality (five) of helical convolutions 331-335 which extend in a clock-wise direction from a lower end convolution 314 of the coil-in-coil spring 310 to the upper end convolution 316 of the inner coil 330 similar to the inner coil 130 of the coil-in-coil spring 110 shown in FIG. 1. Likewise, the outer coil 340 includes an upper end convolution 312 and a plurality (four) of helical convolutions 341-344 which extend in a counter-clockwise direction from the lower end convolution 314 of the coil-in-coil spring 310 to the upper end convolution 312 of the outer coil 340 similar to the outer coil 140 of the coil-in-coil spring 110 shown in FIG. 1.

With respect to the diameters and pitches included in the coil-in-coil spring 310 of FIG. 3, the convolutions 341-344 of the outer coil 340 of the coil-in-coil spring 310 have diameters and pitches substantially similar to the outer coil 140 of the coil-in-coil spring 110 shown in FIG. 1, but this is not necessarily the same across all embodiments of the present invention.

Likewise, the convolutions 331-335 of the inner coil 330 of the coil-in-coil spring 310 of FIG. 3 have diameters and pitches substantially similar to the inner coil 130 of the coil-in-coil spring 110 shown in FIG. 1, but this is not necessarily the same across all embodiments of the present invention.

Similar to the coil-in-coil spring 110 shown in FIG. 1, in the exemplary coil-in-coil spring 310 shown in FIG. 3, the continuous wire 320 ranges from about 13.75 gauge to about 17 gauge. Furthermore, the continuous wire 320 has a tensile strength of between about 270 kpsi to about 320 kpsi, but this is not necessarily the same across all embodiments of the present invention.

However, while the wire gauge in the exemplary coil-in-coil spring 110 shown in FIG. 1 is substantially the same along the entire length of the continuous wire 120 (i.e., the gauge of the inner coil 130 is the same as the gauge of the outer coil 140), in the exemplary coil-in-coil spring 310 shown in FIG. 3, the wire gauge changes at a first transition point 352 along the inner coil 330 and also at a second transition point 354 along the outer coil 340 such that the gauge of the wire forming the lower portion 350 of the coil-in-coil spring 310 (i.e., a lower portion of both the inner coil 330 and the outer coil 340) is different than the gauge of the wire forming the upper portion 360 of the coil-in-coil spring 310 (i.e., an upper portion of both the inner coil 330 and the outer coil 340) which is illustrated in FIG. 3 by the lower portion 350 drawn in solid lines and the upper portion 360 drawn in dashed lines.

In some particular embodiments, the gauge of the wire forming the lower portion 350 of the coil-in-coil spring 310 is heavier than the gauge of the wire forming the upper portion 360 of the coil-in-coil spring 310. More specifically, in the exemplary embodiment shown in FIG. 3, the lower end convolution 314 of the coil-in-coil spring 310, the four lowermost helical convolutions 331-334 of the inner coil 330, and the two lowermost helical convolutions 341-342 of the outer coil 340 is formed of 14 gauge wire. By comparison, the upper end convolution 316 of the inner coil 330, the uppermost helical convolution 335 of the inner coil 330, the upper end convolution 312 of the outer coil 340, and the two uppermost helical convolutions 343-344 of the outer coil 340 is formed of 15 gauge wire.

In some alternate embodiment, however, the gauge of the wire forming the lower portion of both the inner coil 330 and the outer coil 340 is lighter than the gauge of the wire forming the upper portion of both the inner coil 330 and the outer coil 340. More specifically, the lower end convolution 314 of the coil-in-coil spring 310, the four lowermost helical convolutions 331-334 of the inner coil 330, and the two lowermost helical convolutions 341-342 of the outer coil 340 is formed of 15 gauge wire. By comparison, the upper end convolution 316 of the inner coil 330, the two uppermost helical convolutions 334-335 of the inner coil 330, the upper end convolution 312 of the outer coil 340, and the two uppermost helical convolutions 343-344 of the outer coil 340 is formed of 14 gauge wire.

In the exemplary coil-in-coil spring shown in FIG. 3, the transition between the lighter gauge wire and the heavier gauge wire is approximately halfway up the height of the coil-in-coil spring. In other embodiments, however, the transition may occur closer to the top or bottom of the coil-in-coil spring. Furthermore, while the first transition point 352 and the second transition point 354 are located at substantially the same height of the inner coil 330 and the outer coil 340 in the exemplary coil-in-coil spring 310 shown in FIG. 3, in other embodiments, the transitions may occur at different heights for the different coils. In some particular embodiments, either the inner coil or the outer coil may not have any change in the gauge in wire whatsoever.

The coil-in-coil spring 210 shown in FIG. 2 includes a single transition point 252 and the coil-in-coil spring 310 shown in FIG. 3 includes two transition points 352, 354. However, the number and location of transition points is not limited. Further still, while the coil-in-coil springs 210, 310 have only two different wire gauges, in other embodiments, there may be three or more different wire gauges used in a single coil-in-coil spring.

Regardless of the particular configuration of the coil-in-coil spring in which the wire gauge varies for different portions, it is contemplated that changing the gauge of the wire can be accomplished through a variety of different means. Depending on the methods used, the transition between different wire gauges may occur gradually or suddenly. According to some exemplary implementations, a feed wire is provided through a set of rollers when forming the coil-in-coil springs of the present invention. In order to change the gauge of the wire at different portions in the coil-in-coil spring, the rollers compress the wire harder to create a thinner, higher gauge, wire. Additionally or alternatively, a variable opening wire drawing tool can be provided inline which can increase or decrease the size of the opening to modify the gauge of the wire forming the coil-in-coil spring. Further still, two differently sized feed wires may be provided with inline welding performed at the desired point of transition. The above methods are merely exemplary and should not be considered limiting.

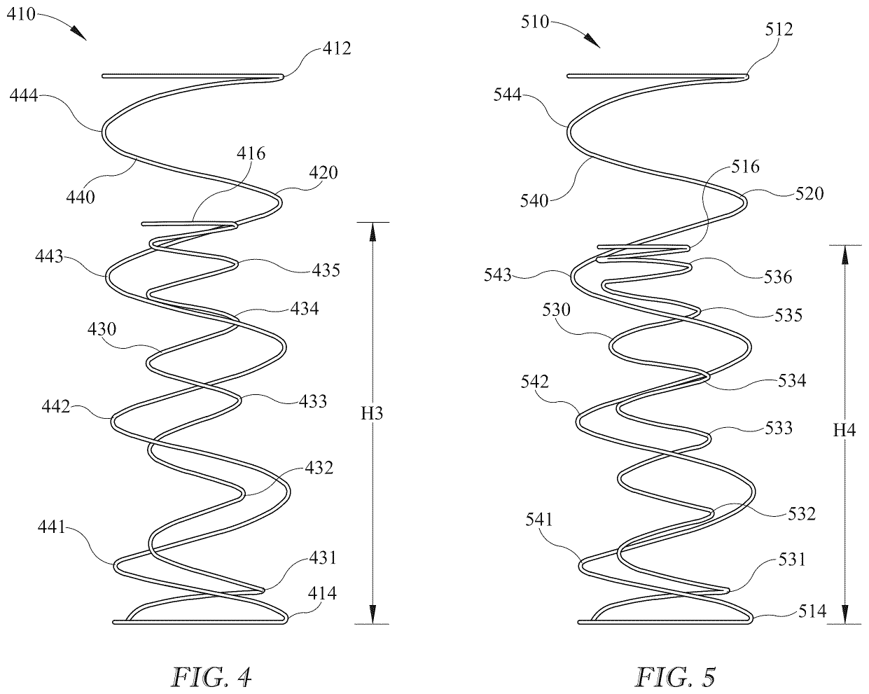

Rather than changing the spring constants of the inner coil and/or the outer coil, another means of developing alternative compression characteristics is to change the compression distance required before the inner coil is engaged. As shown in FIGS. 4-5 and described below, in some exemplary embodiments, the uncompressed height of the inner coil is greater than the uncompressed height H2 of the inner coil 130 shown in FIG. 1, and therefore less compression is required before the spring constant of the coil-in-coil spring increases, resulting in an overall firmer feel.

Referring now to FIG. 4 in particular, in yet another exemplary embodiment, a coil-in-coil spring 410 is provided, which similar to the coil-in-coil spring 110 shown in FIG. 1 aside from the pitch of the inner coil. The coil-in-coil spring 410 of FIG. 4 is made of a continuous wire 420 forming an inner coil 430 having a substantially cylindrical shape and an outer coil 440 extending around the inner coil 430 and having a substantially cylindrical shape. More specifically, the inner coil 430 of the coil-in-coil spring 410 includes an upper end convolution 416 and a plurality (five) of helical convolutions 431-435 which extend in a clock-wise direction from a lower end convolution 414 of the coil-in-coil spring 410 to the upper end convolution 416 of the inner coil 430 similar to the inner coil 130 of the coil-in-coil spring 110 shown in FIG. 1. Likewise, the outer coil 440 of the coil-in-coil spring 410 of FIG. 4 includes an upper end convolution 412 and a plurality (four) of helical convolutions 441-444 which extend in a counter-clockwise direction from the lower end convolution 414 of the coil-in-coil spring 410 to the upper end convolution 412 of the outer coil 440 similar to the outer coil 140 of the coil-in-coil spring 110 shown in FIG. 1.

With respect to the diameters and pitches included in the coil-in-coil spring 410 of FIG. 4, the convolutions 441-444 of the outer coil 440 of the coil-in-coil spring 410 have diameters and pitches substantially similar to the outer coil 140 of the coil-in-coil spring 110 shown in FIG. 1.

The convolutions 431-435 of the inner coil 430 of the coil-in-coil spring 410 of FIG. 4 have diameters substantially similar to the inner coil 130 of the coil-in-coil spring 110 shown in FIG. 1, but the pitch defined between each of the four helical convolutions 431-434 of the inner coil 430 is larger than the pitch defined between each of the four helical convolutions 131-134 of the inner coil 130 of FIG. 1.

Accordingly, the inner coil 430 has an uncompressed height, H3, greater than the uncompressed height H2 of the inner coil 130 shown in FIG. 1, as discussed further below.

Referring now to FIG. 5, in yet another exemplary embodiment, a coil-in-coil spring 510 is provided, which similar to the coil-in-coil spring 110 shown in FIG. 1 aside from the number of coils included in the inner coil. The coil-in-coil spring 510 of FIG. 5 is made of a continuous wire 520 forming an inner coil 530 having a substantially cylindrical shape and an outer coil 540 extending around the inner coil 530 and having a substantially cylindrical shape. More specifically, the inner coil 530 of the coil-in-coil spring 510 includes an upper end convolution 516 and a plurality (six) of helical convolutions 531-536 which extend in a clock-wise direction from a lower end convolution 514 of the coil-in-coil spring 510 to the upper end convolution 516 of the inner coil 530 similar to the inner coil 130 of the coil-in-coil spring 110 shown in FIG. 1. Likewise, the outer coil 540 includes an upper end convolution 512 and a plurality (four) of helical convolutions 541-544 which extend in a counter-clockwise direction from the lower end convolution 514 of the coil-in-coil spring 510 to the upper end convolution 512 of the outer coil 540 similar to the outer coil 140 of the coil-in-coil spring 110 shown in FIG. 1.

With respect to the diameters and pitches included in the coil-in-coil spring 510 of FIG. 5, the convolutions 541-544 of the outer coil 540 of the coil-in-coil spring 510 have diameters and pitches substantially similar to the outer coil 140 of the coil-in-coil spring 110 shown in FIG. 1.

The convolutions 531-536 of the inner coil 530 of the coil-in-coil spring 510 of FIG. 5 have diameters and pitches substantially similar to the inner coil 130 of the coil-in-coil spring 110 shown in FIG. 1. However, as previously mentioned, there are a total of six intermediate convolution 531-536 of the inner coil 530 shown in FIG. 5 as compared to the five intermediate convolutions 131-135 of the inner coil 130 shown in FIG. 1.

Accordingly, the inner coil 530 has an uncompressed height, H4, greater than the uncompressed height H2 of the inner coil 130 shown in FIG. 1.

As compared to the coil-in-coil spring 110 shown in FIG. 1, the coil-in-coil spring 410 shown in FIG. 4 and the coil-in-coil spring 510 shown in FIG. 5 require a smaller first predetermined compression distance before the respective outer coils 440, 540 are compressed until the compressed height of the coil-in-coil spring 410, 510 (i.e., the compressed height of the outer coil 440, 540) is the same as the uncompressed heights H3, H4 of the inner coil 430, 530 at which point both the outer coil 440, 540 and the inner coil 430, 530 compress simultaneously and the compressed height of the coil-in-coil spring 410, 510 is the same as both the compressed height of the outer coil 440, 540 and the compressed height of the inner coil 430, 530.

As such, for the coil-in-coil spring 410 shown in FIG. 4 and the coil-in-coil spring 510 shown in FIG. 5, the spring constant increases (e.g., from K1 to K2), and the coil-in-coil spring 410, 510 becomes “harder” with less compression as compared to the coil-in-coil spring 110 shown in FIG. 1. Thus, the coil-in-coil springs 410, 510 of FIGS. 4-5 provide more support than the coil-in-coil spring 110 of FIG. 1 but still exhibit a variable and non-linear response to loading.

Although the above description of FIGS. 4-5 refers to a change in height of the inner coils 430, 530 as compared to the inner coil 130 shown in FIG. 1, it is contemplated that the height of the outer coils 440, 540 could also be modified (e.g., by adjusting the pitch or number of convolutions) to change the support characteristics of the coil-in-coil springs 410, 510 as compared to the coil-in-coil spring 110 shown in FIG. 1.

Alternative compression characteristics in coil-in-coil springs can be developed through a number of other methods in addition to or instead of the methods described above (i.e., varying wire gauge or inner/outer coil heights). For example, in some embodiments, varying the diameters and/or pitches of the individual convolutions of the inner coil and/or outer coil will affect the compression characteristics. In other words, the inner coil and/or the outer coil may be formed to have a shape other than the cylindrical shapes shown in FIGS. 1-5. A non-limiting example of shapes that the inner coil and/or the outer coil or even a portion thereof (i.e., an uppermost portion, a middle portion, or a lowermost portion) include stovepipe, hourglass, conical, funnel, and barrel shapes.

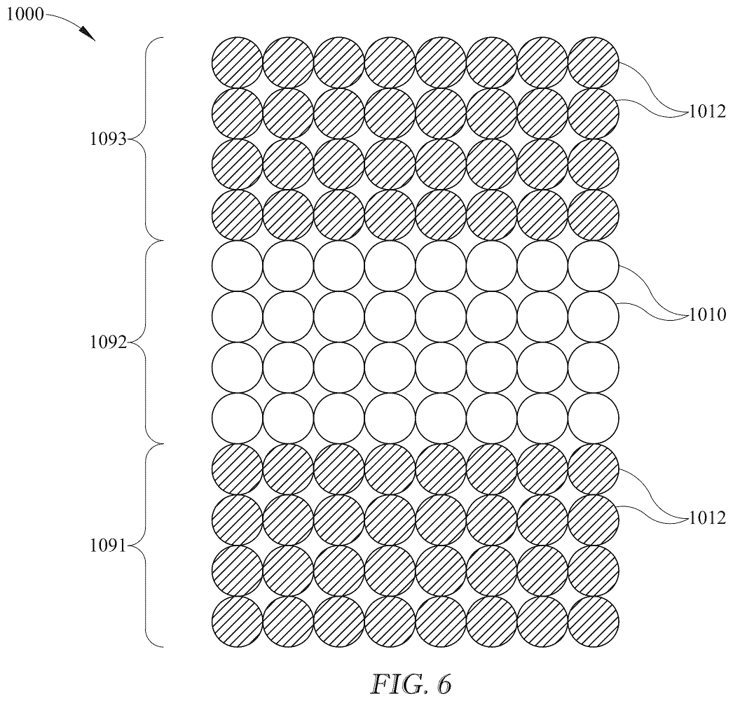

As a further refinement of the present invention, and turning now to FIGS. 6-10, it is also contemplated that any of the above-described coil-in-coil springs 110, 210, 310, 410, 510 as well as other variations described but not shown can be provided in a spring assembly that comprises a first support zone with a first plurality of coil-in-coil springs having a first compression characteristic and a second support zone with a second plurality of coil-in-coil springs having a second compression characteristic. In fact, it is contemplated that any of the exemplary coil-in-coil springs 110, 210, 310, 410, 510 described above with respect to FIGS. 1-5 as well as other variations described but not shown could be included individually or in combination within any of the spring assemblies described below.

Referring now specifically to FIG. 6, in one embodiment of the present invention, an exemplary spring core 1000 is provided that comprises a plurality of coil-in-coil springs arranged in a first support zone and a second support zone. In the embodiment shown in FIG. 6, the spring core 1000 can be characterized as including a foot portion 1091, a head portion 1093, and a middle portion 1092 positioned between the foot portion 1091 and the head portion 1093. The first support zone comprises the foot portion 1091 and the head portion 1093, and the second support zone comprises the middle portion 1092. More specifically, the foot portion 1091 and the head portion 1093 (i.e., the first support zone) of the spring core 1000 comprise a plurality of coil-in-coil springs 1012 with a first support characteristic and the middle portion 1092 (i.e., the second support zone) comprises a plurality of coil-in-coil springs 1010 with a second support characteristic different than the first support characteristic. As one example, the plurality of coil-in-coil springs 1012 of the first support zone and the plurality of coil-in-coil springs 1010 of the second support zone may be formed substantially similar to the coil-in-coil spring 110 of FIG. 1 except that the plurality of coil-in-coil springs 1012 of the first support zone are formed of a first wire gauge and the plurality of coil-in-coil springs 1010 of the second support zone are formed of a second wire gauge different from the first wire gauge. In another example, the plurality of coil-in-coil springs 1012 of the first support zone may be formed substantially similar to the coil-in-coil spring 110 of FIG. 1 while the plurality of coil-in-coil springs 1010 of the second support zone may be formed substantially similar to the coil-in-coil spring 210 of FIG. 2.

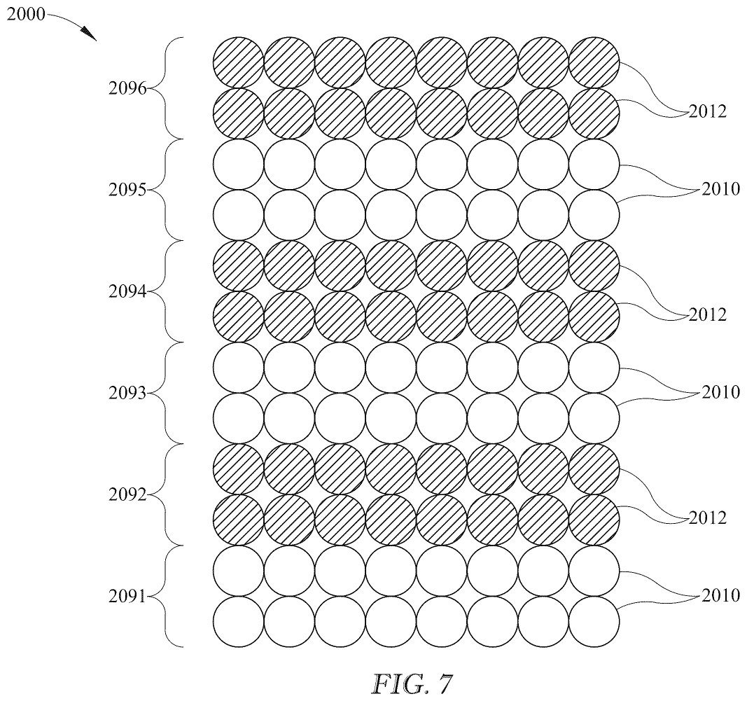

Referring now specifically to FIG. 7, in another exemplary spring core 2000 with a first support zone and a second support zone, the spring core 2000 can be characterized as including six alternating zones 2091-2096 that each include the same number of rows of coil-in-coil springs. In FIG. 7 each of the zones 2091-2096 has two rows of coil-in-coil springs, but this is merely illustrative and should not be considered limiting. The first support zone comprises the first zone 2091, the third zone 2093, and the fifth zone 2095, and the second support zone comprises the second zone 2092, the fourth zone 2094, and the sixth zone 2096. More specifically, the first support zone of the spring core 2000 comprise a plurality of coil-in-coil springs 2010 with a first support characteristic and the second support zone comprises a plurality of coil-in-coil springs 2012 with a second support characteristic different than the first support characteristic. As one example, the plurality of coil-in-coil springs 2010 of the first support zone may be formed substantially similar to the coil-in-coil spring 210 of FIG. 2 while the plurality of coil-in-coil springs 2012 of the second support zone may be formed substantially similar to the coil-in-coil spring 110 of FIG. 1.

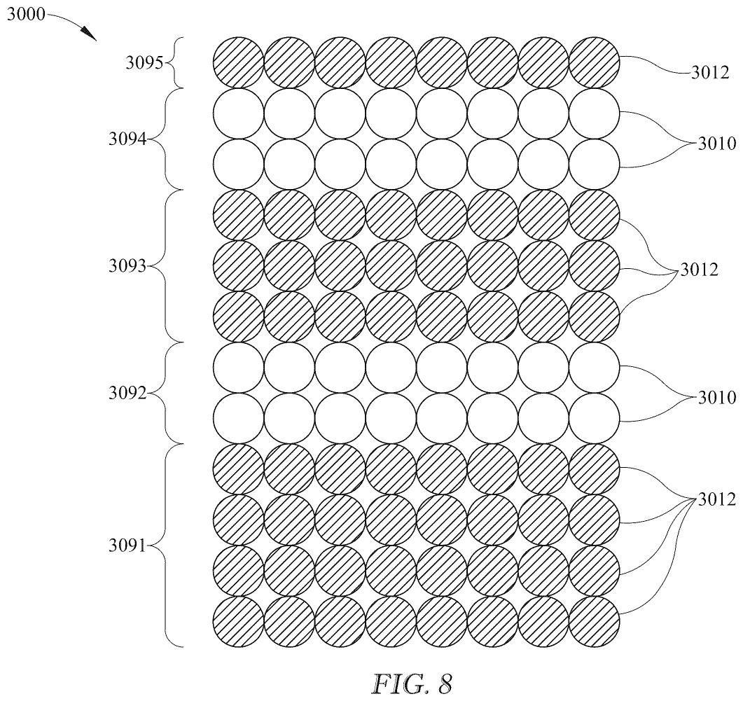

Referring now specifically to FIG. 8, in another exemplary spring core 3000 with a first support zone and a second support zone, the spring core 3000 can be characterized as including five alternating zones 3091-3095 that have varying sizes. In FIG. 8, the first zone 3091 has four rows of coil-in-coil springs, the second zone 3092 has two rows of coil-in-coil springs, the third zone 3093 has three rows of coil-in-coil springs, the fourth zone 3094 has two rows of coil-in-coil springs, and the fifth zone 3095 has one row of coil-in-coil springs, but this is merely illustrative and should not be considered limiting. The first support zone comprises the first zone 3091, the third zone 3093, and the fifth zone 3095, and the second support zone comprises the second zone 3092 and the fourth zone 3094. More specifically, the first support zone of the spring core 3000 comprise a plurality of coil-in-coil springs 3012 with a first support characteristic and the second support zone comprises a plurality of coil-in-coil springs 3010 with a second support characteristic different than the first support characteristic. As one example, the plurality of coil-in-coil springs 3012 of the first support zone may be formed substantially similar to the coil-in-coil spring 110 of FIG. 1 while the plurality of coil-in-coil springs 3010 of the second support zone may be formed substantially similar to the coil-in-coil spring 210 of FIG. 2.

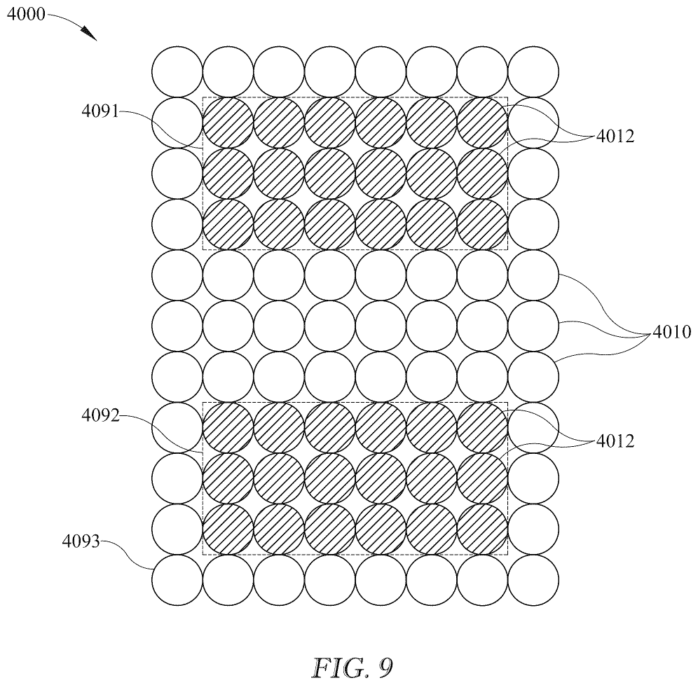

Referring now specifically to FIG. 9, in another exemplary spring core 4000 with a first support zone and a second support zone, the spring core 4000 can be characterized as including a torso support portion 4091, a leg support portion 4092, and a peripheral portion 4093 positioned around each of the torso support portion 4091 and leg support portion 4092. Once again, the particular number of coil-in-coil springs shown in FIG. 9 is merely illustrative and should not be considered limiting. The first support zone comprises the torso support portion 4091 and leg support portion 4092, and the second support zone comprises the peripheral portion 4093. More specifically, the first support zone of the spring core 4000 comprise a plurality of coil-in-coil springs 4012 with a first support characteristic and the second support zone comprises a plurality of coil-in-coil springs 4010 with a second support characteristic different than the first support characteristic. As one example, the plurality of coil-in-coil springs 4012 of the first support zone may be formed substantially similar to the coil-in-coil spring 210 of FIG. 2 while the plurality of coil-in-coil springs 4010 of the second support zone may be formed substantially similar to the coil-in-coil spring 110 of FIG. 1.

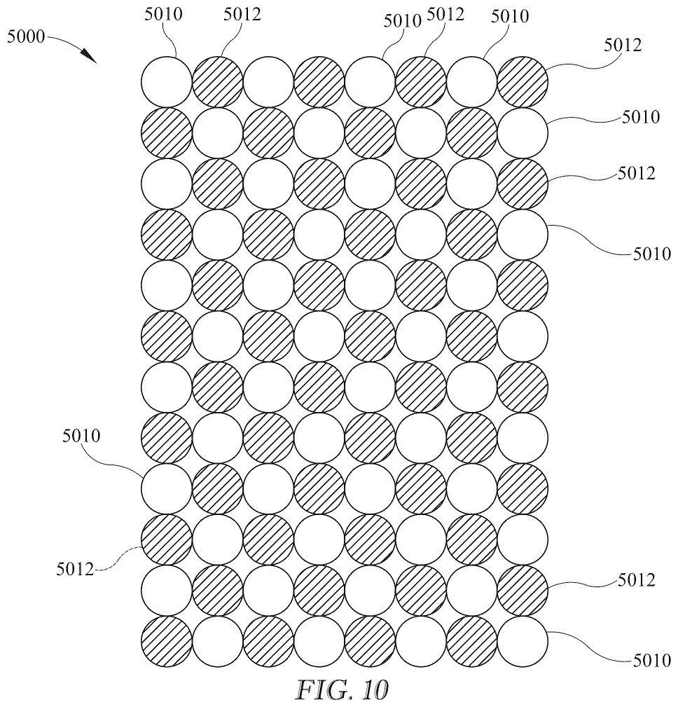

Referring now specifically to FIG. 10, in another exemplary spring core 5000 with a first support zone and a second support zone, the spring core 5000 can be characterized as including coil-in-coil springs arranged in a checkerboard pattern across the spring core to provide a predetermined support characteristic to the spring core. For example, a plurality of coil-in-coil springs 5012 may be formed substantially similar to the coil-in-coil spring 110 of FIG. 1 while another plurality of coil-in-coil springs 5010 may be formed substantially similar to the coil-in-coil spring 210 of FIG. 2.

Of course, the patterns shown in FIGS. 6-10 are not limiting in any way and a spring core of the present invention can have any number of different patterns across the spring core without departing from the spirit and scope of the present invention.

Similarly, although the coil-in-coil spring 110 of FIG. 1 and the coil-in-coil spring 210 of FIG. 2 were used as an example, spring cores made in accordance with the present invention may use any combination of the above-described coil-in-coil springs 110, 210, 310, 410, 510. Furthermore, each spring core may have more than two different forms of coil-in-coil springs without departing from the spirit and scope of the present invention.

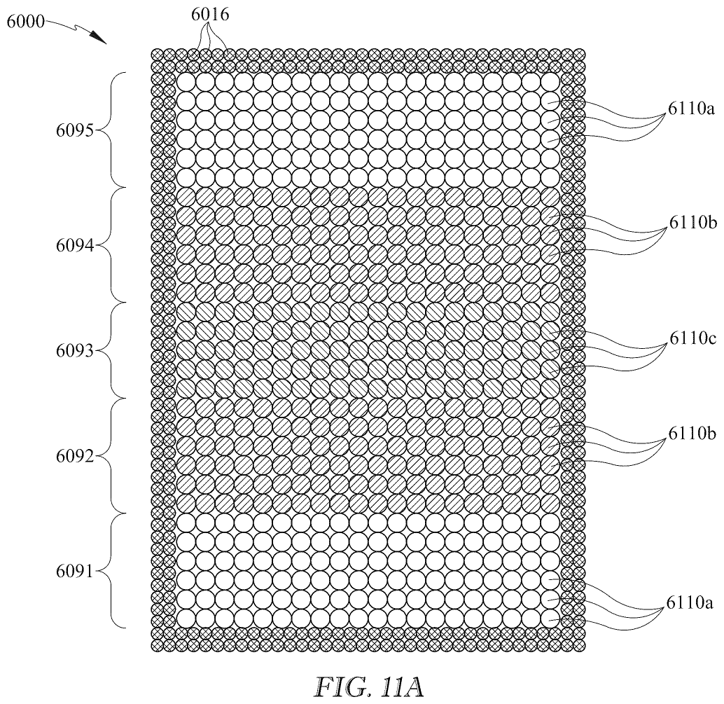

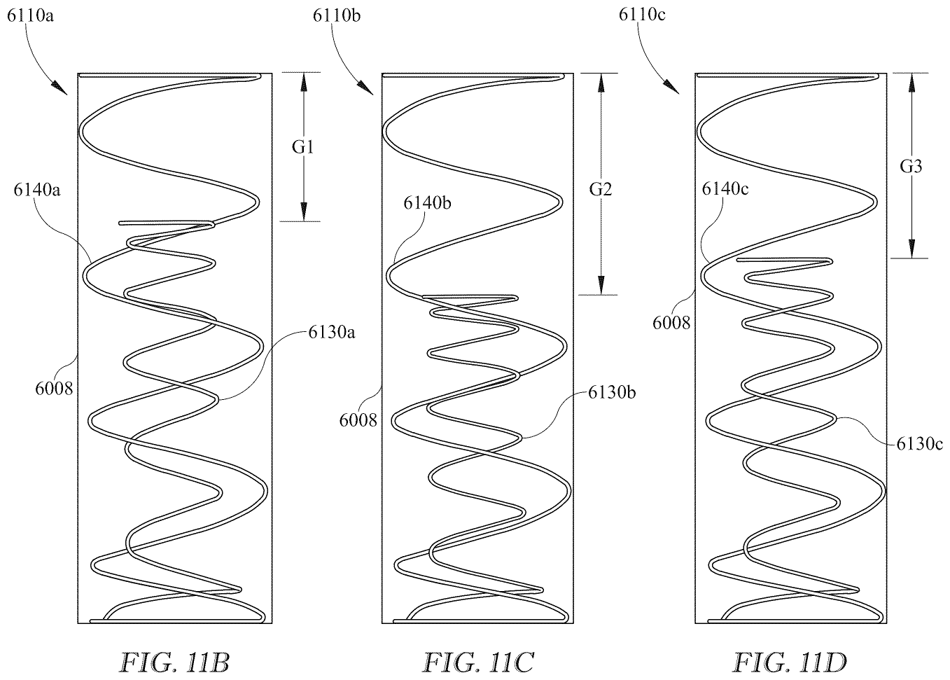

Referring now to FIG. 11A, in one particular embodiment of the present invention, an exemplary spring core 6000 is provided that comprises a plurality of pocketed coil-in-coil springs assemblies arranged in a plurality of support zones. In the embodiment shown in FIG. 11A, the spring core 6000 can be characterized as including five support zones 6091-6095 which are arranged sequentially from a first support zone 6091 at the foot end of the spring core 6000 to a fifth support zone 6095 at the head end of the spring core 6000. The five support zones 6091-6095 are surrounded by a border of smaller pocketed coil springs 6016. The support characteristics of the five support zones 6091-6095 differ based upon the uncompressed height of the inner coils in a manner similar to the coil-in-coil spring 410 described above with respect to FIG. 4, namely, by changing the pitch between the convolutions of the inner coils.

In particular, and referring now to FIGS. 11A and 11B, the first support zone 6091 and the fifth support zone 6095 of the spring core 6000 each comprise a plurality of coil-in-coil springs 6110a that include an inner coil 6130a and an outer coil 6140a substantially similar to the coil-in-coil spring 110 of FIG. 1. Importantly, the inner coil 6130a has an uncompressed height such that there is a gap G1 between the upper end convolution of the inner coil 6130a and the upper end convolution of the outer coil 6140a. In the exemplary spring core 6000 the gap G1 is ⅞″ between the upper end convolution of the inner coil 6130a and the upper end convolution of the outer coil 6140a. As such, the coil-in-coil springs 6110a in the first support zone 6091 and the fifth support zone 6095 will compress a distance of ⅞″ with only the outer coil 6140a compressing such that an initial spring constant K1a of the coil-in-coil spring 6110a is based solely on the outer coil 6140a. When the coil-in-coil springs 6110a in the first support zone 6091 and the fifth support zone 6095 are compressed a distance greater than ⅞″, both the outer coil 6140a and the inner coil 6130a are compressed together such that a second spring constant K2a of the coil-in-coil spring 6110a is based on both the inner coil 6130a as well as the outer coil 6140a. As the spring constant increases from K1a to K2a, the coil-in-coil spring 6110a becomes “harder” once it is compressed more than ⅞″.

Similarly, and referring now to FIGS. 11A and 11C, the second support zone 6092 and the fourth support zone 6094 of the spring core 6000 comprise a plurality of coil-in-coil springs 6110b that include an inner coil 6130b and an outer coil 6140b substantially similar to the coil-in-coil spring 110 of FIG. 1. Importantly, the inner coil 6130b has an uncompressed height such that there is a gap G2 between the upper end convolution of the inner coil 6130b and the upper end convolution of the outer coil 6140b. In the exemplary spring core 6000 the gap G2 is 1⅞″ between the upper end convolution of the inner coil 6130b and the upper end convolution of the outer coil 6140b. As such, the coil-in-coil springs 6110b in the second support zone 6092 and the fourth support zone 6094 will compress a distance of 1⅞″ with only the outer coil 6140b compressing such that an initial spring constant K1b of the coil-in-coil spring 6110b is based solely on the outer coil 6140b. When the coil-in-coil springs 6110b in the second support zone 6092 and the fourth support zone 6094 are compressed a distance greater than 1⅞″, both the outer coil 6140b and the inner coil 6130b are compressed together such that a second spring constant K2b of the coil-in-coil spring 6110b is based on both the inner coil 6130b as well as the outer coil 6140b. As the spring constant increases from K1b to K2b, the coil-in-coil spring 6110b becomes “harder” once it is compressed more than 1⅞″.

Likewise, and referring now to FIGS. 11A and 11D, the third support zone 6093 of the spring core 6000 comprise a plurality of coil-in-coil springs 6110c that include an inner coil 6130c and an outer coil 6140c substantially similar to the coil-in-coil spring 110 of FIG. 1. Importantly, the inner coil 6130c has an uncompressed height such that there is a gap G3 between the upper end convolution of the inner coil 6130c and the upper end convolution of the outer coil 6140c. In the exemplary spring core 6000 the gap G3 is 1⅜″ between the upper end convolution of the inner coil 6130c and the upper end convolution of the outer coil 6140c. As such, the coil-in-coil springs 6110c in the third support zone 6093 will compress a distance of 1⅜″ with only the outer coil 6140c compressing such that an initial spring constant K1c of the coil-in-coil spring 6110c is based solely on the outer coil 6140c. When the coil-in-coil springs 6110c in the third support zone 6093 are compressed a distance greater than 1⅜″, both the outer coil 6140c and the inner coil 6130c are compressed together such that a second spring constant K2c of the coil-in-coil spring 6110c is based on both the inner coil 6130c as well as the outer coil 6140c. As the spring constant increases from K1c to K2c, the coil-in-coil spring 6110c becomes “harder” once it is compressed more than 1⅜″.

Because the gap G1 is less than the gap G2 and G3, the first support zone 6091 and the fifth support zone 6095 provide the firmest feel, and because the gap G2 is greater than the gap G3, the second support zone 6092 and the fourth support zone 6094 provide the softest feel. Table 1 below provides the loading profile of the exemplary spring core 6000, but other support characteristics are possible by modifying the coil-in-coil springs within one or more of the zones in accordance with the above descriptions.

TABLE 1

| | 1″ load | 1.5″ load | 2″ load |
|---|---|---|---|
| | (lbf) | (lbf) | (lbf) |
| Zone 5 | 51.65 | 77.08 | 106.26 |
| Zone 4 | 44.05 | 60.4 | 82.19 |
| Zone 3 | 43.71 | 60.51 | 85.37 |
| Zone 2 | 44.05 | 60.4 | 82.19 |
| Zone 1 | 51.65 | 77.08 | 106.26 |

As previously mentioned, the spring core 6000 shown in FIG. 11 comprises a plurality of pocketed coil-in-coil springs assemblies arranged in a plurality of support zones. A pocketed coil-in-coil spring includes a flexible enclosure 6008 that encases each of the coil-in-coil springs 6010a, 6010b, 6010c. The flexible enclosure is preferably made of a material, such as a fabric, which can joined or welded together by heat and pressure (e.g., via ultrasonic welding or similar thermal welding procedure). For example, suitable fabrics may include one of various thermoplastic fibers known in the art, such as non-woven polymer-based fabric, non-woven polypropylene material, or non-woven polyester material. Alternatively, the flexible enclosure may be joined together by stitching, metal staples, or other suitable methods. In short, a wide variety of fabrics or similar sheet material may be used to make and join together the flexible enclosure as would be recognized by those skilled in the art. Regardless, it is contemplated that in some embodiments, the flexible enclosures 6008 are sized such that the outer coils 6140a, 6140b, 6140c are preferably in a slightly compressed state in which for example the total nominal height of the outer coils 6140a, 6140b, 6140c is slightly reduced. Although not expressly shown, it should be understood that, in some exemplary embodiments of the spring cores 1000-5000 described above with respect to FIGS. 6-10, the coil-in-coil springs are likewise provided as a pocketed coil-in-coil spring including a coil-in-coil spring (e.g., one of the coil-in-coil springs 110, 210, 310, 410, 510 described above with reference to FIGS. 1-5), but that further comprises a flexible enclosure that encases the coil-in-coil spring.

Each of the spring cores 1000-6000 shown in FIGS. 6-11 include coil-in-coil springs arranged in a rectangular matrix, i.e., with each of the coil-in-coil springs arranged in straight columns and rows. However, these are merely non-limited examples and other arrangements of the coil-in-coil springs are possible without departing from the spirit and scope of the present invention. For example, in some embodiments, each row of coil-in-coil springs may be offset such that the coil-in-coil springs of one row are positioned between two adjacent coil-in-coil springs of an adjacent row. It is contemplated that a “nested” arrangement can increase the coil density and therefore overall support characteristics of the spring core.

In some embodiments, rather than having clearly distinguished zones that include one single type of coil, a spring core (or one or more zones within the spring core) made in accordance with the present invention may have a gradual transition across one dimension (e.g., the length or width) or two dimensions (e.g., both length and width). The transition may extend across any number of coil-in-coil springs. In one particular embodiment of the present invention, a spring core is provided with a gradient of support across the spring core. For example, and with reference to the graph below, the support may initially increase from a head portion (leftmost in the graph) to a torso portion (middle of the graph) before decreasing at a foot portion (rightmost in the graph). Of course, this is merely exemplary and the support characteristics may vary according to any number shapes. The means of varying support from one coil-in-coil spring is also non-limiting and any combination of coil-in-coil springs discussed above may be chosen for each location in the spring core to achieve the desired support characteristics. However, it is contemplated that one particular means is to vary the height of the inner coil in a manner corresponding to the desired support. That is to say with reference to the graph below, the height of the coil springs along the location corresponds to the support, i.e., initially increasing from a head portion (leftmost in the graph) to a torso portion (middle of the graph) before decreasing at a foot portion (rightmost in the graph). In one particular embodiment, the inner coil height may increase by 5 mm per coil over 5-10 coils and then come back down to the first height in 5 mm increments over 5-10 more coils. Of course, the particular height changes (both incremental and total) as well as the distance over which the changes occur are not limited and will depend on the particular intended support characteristic.

One of ordinary skill in the art will recognize that additional embodiments are also possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become apparent to those skilled in the art upon reading this disclosure and may be made without departing from the spirit or scope of the claimed invention.

What is claimed is:

1. A coil-in-coil spring comprising:
a lower end convolution;
an outer coil including a plurality of helical convolutions extending from the lower end convolution to an upper end convolution of the outer coil; and
an inner coil including a plurality of helical convolutions extending from the lower end convolution to an upper end convolution of the inner coil;
wherein a first portion of the coil-in-coil spring is formed of a wire having a first gauge and a second portion of the coil-in-coil spring is formed of a wire having a second gauge different from the first gauge.

2. The coil-in-coil spring of claim 1, wherein the coil-in-coil spring is made of a continuous wire forming the inner coil and the outer coil.

3. The coil-in-coil spring of claim 2, wherein the continuous wire has a gauge that varies between 13.75 gauge and 17 gauge.

4. The coil-in-coil spring of claim 1, wherein the first gauge is lighter than the second gauge.

5. The coil-in-coil spring of claim 1, wherein the first gauge is 15 gauge and the second gauge is 14 gauge.

6. The coil-in-coil spring of claim 1, wherein the first gauge is heavier than the second gauge.

7. The coil-in-coil spring of claim 1, wherein the first gauge is 14 gauge and the second gauge is 15 gauge.

8. The coil-in-coil spring of claim 1, wherein the first portion of the coil-in-coil spring includes the outer coil and the second portion of the coil-in-coil spring includes the inner coil.

9. The coil-in-coil spring of claim 1, wherein the first portion of the coil-in-coil spring includes a lower portion of both the outer coil and the inner coil and the second portion of the coil-in-coil spring includes an upper portion of both the inner coil and the outer coil.

10. The coil-in-coil spring of claim 9, wherein the first gauge is lighter than the second gauge.

11. A spring core of a mattress comprising:
a first support zone including a plurality of pocketed coil-in-coil springs, each of the plurality of pocketed coil-in-coil springs of the first support zone including
an inner coil, and
an outer coil extending around the inner coil; and
a second support zone including a plurality of pocketed coil-in-coil springs, each of the plurality of pocketed coil-in-coil springs of the second support zone including
an inner coil, and
an outer coil extending around the inner coil;
wherein the plurality of pocketed coil-in-coil springs of the first support zone have a first compression characteristic and the plurality of pocketed coil-in-coil springs of the second support zone have a second compression characteristic different than the first compression characteristic.

12. The spring core of claim 11, wherein for each of the plurality of pocketed coil-in-coil springs of the first support zone
the inner coil has an first uncompressed height, and
the outer coil has a second uncompressed height greater than the first uncompressed height; and
wherein for each of the plurality of pocketed coil-in-coil springs of the second support zone
the inner coil has a third uncompressed height greater than the first uncompressed height and less than the second uncompressed height, and
the outer coil has the second uncompressed height.

13. The spring core of claim 11, wherein for each of the plurality of pocketed coil-in-coil springs of the first support zone, the inner coil and the outer coil is made of a continuous wire having a single gauge; and
wherein for each of the plurality of pocketed coil-in-coil springs of the second support zone the inner coil is made of a continuous wire having a first gauge and the outer coil is made of a wire having a second gauge different than the first gauge.

14. The spring core of claim 11, wherein for each of the plurality of pocketed coil-in-coil springs of the first support zone, the inner coil and the outer coil is made of a continuous wire having a single gauge; and
wherein for each of the plurality of pocketed coil-in-coil springs of the second support zone an upper portion of the inner coil and an upper portion of the outer coil is made of a wire having a first gauge and a lower portion of the inner coil and a lower portion of the outer coil is made of a continuous wire having a second gauge different than the first gauge.

15. The spring core of claim 11, wherein the spring core can be characterized as including a foot portion, a head portion, and a middle portion positioned between the foot portion and the head portion,
wherein the first support zone comprises the foot portion, the head portion, or both the foot portion and the head portion, and
wherein the second support zone comprises the middle portion.

16. The spring core of claim 11, wherein the first support zone and the second support zone comprise multiple alternating zones.

17. The spring core of claim 11, wherein the spring core can be characterized as including a central portion and a peripheral portion extending around the central portion,
wherein the first support zone comprises the central portion, and
wherein the second support zone comprises the peripheral portion.

18. The spring core of claim 11, wherein the spring core can be characterized as including a torso support portion and a leg support portion, and
wherein the second support zone comprises the torso support portion and the leg support portion.

19. The spring core of claim 11, wherein the first support zone and the second support zone are arranged in a checkered pattern across the spring core.

20. The spring core of claim 11, further comprising a third support zone including a plurality of pocketed coil-in-coil springs, each of the plurality of pocketed coil-in-coil springs of the third support zone including
an inner coil, and
an outer coil extending around the inner coil;
wherein the plurality of pocketed coil-in-coil springs of the third support zone have a third compression characteristic different than the first compression characteristic and the second compression characteristic.

21. A spring core of a mattress comprising:
a first support zone including a plurality of pocketed coil-in-coil springs, each of the plurality of pocketed coil-in-coil springs of the first support zone including an inner coil, and an outer coil extending around the inner coil, the plurality of pocketed coil-in-coil springs of the first support zone have a first compression characteristic;
a second support zone including a plurality of pocketed coil-in-coil springs, each of the plurality of pocketed coil-in-coil springs of the second support zone including an inner coil, and an outer coil extending around the inner coil, the plurality of pocketed coil-in-coil springs of the second support zone have a second compression characteristic;
a third support zone including a plurality of pocketed coil-in-coil springs, each of the plurality of pocketed coil-in-coil springs of the third support zone including an inner coil, and an outer coil extending around the inner coil, the plurality of pocketed coil-in-coil springs of the third support zone have a third compression characteristic;
a fourth support zone including a plurality of pocketed coil-in-coil springs, each of the plurality of pocketed coil-in-coil springs of the fourth support zone including an inner coil, and an outer coil extending around the inner coil, the plurality of pocketed coil-in-coil springs of the fourth support zone have a fourth compression characteristic; and
a fifth support zone including a plurality of pocketed coil-in-coil springs, each of the plurality of pocketed coil-in-coil springs of the fifth support zone including an inner coil, and an outer coil extending around the inner coil, the plurality of pocketed coil-in-coil springs of the fifth support zone have a fifth compression characteristic;
wherein the five support zones are arranged sequentially with the first support zone at a foot end of the spring core and the fifth support zone at a head end of the spring core; and
wherein the first compression characteristic and the fifth compression characteristic are the same;
wherein the second compression characteristic and the fourth compression characteristic are the same and different than the first compression characteristic and the fifth compression characteristic; and
wherein the third compression characteristic is different than the first compression characteristic, the second compression characteristic, the fourth compression characteristic, and the fifth compression characteristic.
